(19) United States
(12) Patent Application Publication
(10) Pub. No.: US 2017/0037296 A1
(43) Pub. Date: Feb. 9, 2017

(54) PROCESS FOR RECOVERY OF OIL

(71) Applicant: WINTERSHALL HOLDING GMBH, Kassel (DE)

(72) Inventors: Riichiro KIMURA, Jersey City, NJ (US); Andrei-Nicolae PARVULESCU, Ruppertsberg (DE); Stefan MAURER, Pudong (CN); Roelf-Peter BAUMANN, Mannheim (DE); Lolenz SIGGEL, Heidelberg (DE); Ulrich MÜLLER, Neustadt (DE)

(21) Appl. No.: 15/305,549

(22) PCT Filed: Apr. 20, 2015
(86) PCT No.: PCT/EP2015/058491

§ 371 Date: Oct. 20, 2016

(30) Foreign Application Priority Data
Apr. 22, 2014 (EP) 14165410.3

(51) Int. Cl. C09K 8/58; E21B 43/16

(52) U.S. Cl. CPC C09K 8/58; E21B 43/16

(57) ABSTRACT

The present invention relates to a process for recovering oil from an oil-reservoir comprising at least the steps of a) providing solid particles and water, whereby the solid particles comprise at least one layered double hydroxide of general formula (I), b) combining the solid particles and water with the oil in the oil-reservoir, c) mixing the components of step b) to obtain an emulsion containing droplets, wherein the emulsion comprises the solid particles, water and oil, d) transferring the emulsion out of the oil-reservoir, and e) recovering the solid particles of the emulsion.

### CROSS-REFERENCE TO RELATED APPLICATIONS

This application is a national stage application (under 35 U.S.C. §371) of PCT/EP2015/058491, filed Apr. 20, 2015, which claims benefit of European Application No. 14165410.3, filed Apr. 22, 2014, both of which are incorporated herein by reference in their entirety.

The present invention relates to a process for recovering oil from an oil-reservoir comprising at least the steps of a) providing solid particles and water, whereby the solid particles comprise at least one layered double hydroxide of general formula (I), b) combining the solid particles and water with the oil in the oil-reservoir, c) mixing the components of step b) to obtain an emulsion containing droplets, wherein the emulsion comprises the solid particles, water and oil, d) transferring the emulsion out of the oil-reservoir, and e) recovering the solid particles of the emulsion.

The recovery of oil from a reservoir usually results in simultaneous production of water with the oil. In many cases the oil and water are subject to mixing and shearing in subsurface pumps, and this results in the formation of water-in-oil or oil-external emulsions having a viscosity that is substantially higher than that of the original “dry oil”. Because of the wellbore hydraulics, the production of this oil-external emulsion, with its higher viscosity, increases lifting costs.

In natural mineral oil deposits, mineral oil is present in the cavities of porous reservoir rocks which are closed off from the earth's surface by impermeable covering layers. The cavities may be very fine cavities, capillaries, pores or the like. Fine pore necks can have, for example, a diameter of only about 1 μm or less. In addition to crude oil, including natural gas fractions, the deposits comprise water having a higher or lower salt content.

In crude oil production, a distinction is made between primary, secondary and tertiary production.

In primary production, after sinking of the well into the deposit, the mineral oil flows by itself through the well to the surface owing to the autogenous pressure of the deposit. However, in general only from about 5 to 10% of the amount of mineral oil present in the deposit, depending on the type of deposit, can be extracted by means of primary production, after which the autogenous pressure is no longer sufficient for extraction.

Secondary production is therefore used after the primary production. In secondary production, further wells are drilled into the mineral oil-carrying formation, in addition to the wells which serve for production of the mineral oil, the so-called production wells. Water and/or gas is forced into the deposit through these so-called injection wells in order to maintain or to increase again the pressure. By forcing in the water, the mineral oil is forced slowly through the cavities in the formation, starting from the injection well, in the direction of the production well. However, this functions only as long as the cavities are completely filled with oil and the water pushes the more viscous oil in front of it. As soon as the low-viscosity water penetrates through cavities, it flows from this time on along the path of least resistance, i.e. through the resulting channel between the injection wells and the production wells, and no longer pushes the oil in front of it. As a rule, only from about 30 to 35% of the amount of mineral oil present in the deposit can be extracted by means of primary and secondary production.

It is known that the crude oil yield can be further increased by tertiary oil production measures. Tertiary mineral oil production includes processes in which suitable chemicals are used as assistants for oil production. These include the so-called “polymer flooding”. In polymer flooding, an aqueous solution of a polymer having a thickening effect is forced instead of water through injection wells into the crude oil deposit. By forcing in the polymer solution, the mineral oil is forced through said cavities in the formation, starting from the injection well, in the direction of the production well, and the mineral oil is finally extracted via the production well. Owing to the high viscosity of the polymer solution, which is adapted to the viscosity of the mineral oil, the polymer solution can no longer, or at least not so easily, break through cavities as is the case with pure water.

As an alternative approach, water-in-oil macroemulsions have been proposed as a method for producing highly viscous drive fluids that can maintain effective mobility control while displacing moderately viscous oils. For example, the use of water-in-oil and oil-in-water macroemulsions have been evaluated as drive fluids to improve oil recovery of viscous oils. Such emulsions have been created by addition of sodium hydroxide to acidic crude oils. In particular, U.S. Pat. No. 5,927,404 and U.S. Pat. No. 6,068,054 describe oil-in-water and water-in-oil emulsions that are stabilized by solid particles. These emulsions can be used to displace oil in subterranean formations.

U.S. Pat. No. 6,988,550 discloses a method to prepare an oil-in-water emulsion in a subterranean formation in the presence of hydrophilic particles such as bentonite clay and kaolinite clay both of which comprise negatively charged layers and cations in the interlayer spaces.

However, a more economic approach is to form an oil-in-water emulsion containing solid particles in situ in the subterranean oil-containing formation, recover the oil-in-water emulsion and separate off the different components so that the solid particles can be reused.

Wang et al. (Langmuir 2008, 24, pages 10054-10061) disclose double phase inversion of emulsions containing layered double hydroxide particles induced by adsorption of sodium dodecyl sulfate. Therefore a liquid paraffin-water emulsion was investigated using layered double hydroxide (LDH) particles and sodium dodecyl sulfate (SDS) as emulsifiers. Both emulsifiers are well-known to stabilize oil-in-water (o/w) emulsions. A double phase inversion of the emulsion containing LDH particles is induced by the adsorption of SDS.

Zhe An et al. (Chemical Communications, 2013, vol. 49, pages 5912-5920) disclose layered double hydroxide-based catalysts with nanostructure design and catalytic performance. Layered double hydroxides (LDHs) are a class of clays with brucite-like layers and intercalated anions which have attracted increasing interest in the field of catalysis. Benefiting from the atomic-scale uniform distribution of metal cations in the brucite-like layers and the ability to intercalate a diverse range of interlayer anions, LDHs display great potential as precursors/supports to prepare catalysts, in that the catalytic sites can be preferentially orientated, highly dispersed, and firmly stabilized to afford excellent catalytic performance and recyclability.

US 2003/0139299 A1 discloses a solids-stabilized oil-in-water emulsion and a method for preparing the same. The oil-in-water emulsion is formed by combining oil, water, solid particles and a pH enhancing agent and mixing until the solid-stabilized oil-in-water emulsion is formed. The low viscosity oil-in-water emulsion can be used to enhance production of oil from subterranean reservoirs.

Abend et al. (Colloid Polym Sci, 276: pages 730-737 (1998)) disclose a stabilization of emulsions by heterocoagulation of clay minerals and layered double hydroxides. The paraffin/water emulsions were stabilized by colloidal particles without surface active agents. Mixtures of two types of particles with opposite signs of charge were used: a layered double hydroxide (the hydroxide layers carry positive charges) and the clay mineral montmorillonite (the silicate layers carry negative charges). The emulsions were very stable and did not separate a coherent oil phase. The stability of the emulsion (no oil coalescence after centrifugation) was independent of the mixing ratio of both the compounds when the total solid content was >0.5%. Solid contents up to 2.0% were optimal.

Yang et al. (Journal of Colloid and Interface Science, 302 (2006) pages 159-169) disclose pickering emulsions stabilized solely by a layered double hydroxides particles and the effect of salt on emulsion formation and stability. The formation and stability of liquid paraffin-in-water emulsions stabilized solely by positively charged plate-like layered double hydroxides (LDHs) particles were described here. The effects of adding salt into LDHs dispersions on particle zeta potential, particle contact angle, particle adsorption at the oil-water interface and the structure strength of dispersions were studied. It was found that the zeta potential of particles gradually decreased with the increase of salt concentration, but the variation of contact angle with salt concentration was very small. The adsorption of particles at the oil-water interface occurred due to the reduction of particle zeta potential. The structural strength of LDHs dispersions was strengthened with the increase of salt and particle concentrations.

Wang et al. (Langmuir 2010, 26(8), pages 5397-5404) disclose pickering emulsions stabilized by a lipophilic surfactant and hydrophilic plate-like particles. Liquid paraffin-water emulsions were prepared by homogenizing oil phases containing sorbitan oleate (Span 80) and aqueous phases containing layered double hydroxide (LDH) particles or laponite particles. While water-in-oil (w/o) emulsions are obtained by combining LDH with Span 80, the emulsions stabilized by laponite-Span 80 are always o/w types regardless of the Span 80 concentration. Laser-induced fluorescent confocal micrographs indicate that particles are absorbed on the emulsion surfaces, suggesting all the emulsions are stabilized by the particles.

EP 0 557 089 A1 discloses sunscreen formulations comprising water, oil and layered double hydroxides.

The object of the present invention is to provide a process which is highly economic and easy to carry out for recovering oil.

The object of the present invention is achieved by a process for recovering oil from an oil-reservoir comprising at least the steps of:
a) providing solid particles and water,
   whereby the solid particles comprise at least one layered double hydroxide of general formula (I)

[M^{II}₍₁₋ₓ₎M^{III}ₓ(OH)₂]^{x+}[Aⁿ⁻]_{x/n}.y H₂O (I),
wherein
   M^{II} denotes a divalent metal ion or 2 Li,
   M^{III} denotes a trivalent metal ion,
   Aⁿ⁻ denotes at least one n-valent anion comprising:
      (i) a mixture of A1 and A2, or
      (ii) A1,
      whereby
      A1 is selected from the group consisting of alkyl sulfate, alkyl phosphate, alkyl sulfonate, alkyl carboxylate, alkyl phosphanate, alkyl phosphinate and alkyl carbonate, and
      A2 is selected from the group consisting of H⁻, F⁻, Cl⁻, Br⁻, I⁻, OH⁻, CN⁻, NO₃⁻, NO₂⁻, ClO⁻, ClO₂⁻, ClO₃⁻, ClO₄⁻, MnO₄⁻, CH₃COO⁻, HCO₃⁻, H₂PO₄⁻, HSO₄⁻, HS⁻, SCN⁻, [Al(OH)₄]⁻, [Al(OH)₄(H₂O)₂]⁻, [Ag(CN)₂]⁻, [Cr(OH)₄]⁻, [AuCl₄]⁻, O²⁻, S²⁻, O₂²⁻, SO₃²⁻, S₂O₃²⁻, CrO₄²⁻, Cr₂O₇²⁻, HPO₄²⁻, [Zn(OH)₄]²⁻, [Zn(CN)₄]²⁻, [CuCl₄]²⁻, PO₄³⁻, [Fe(CN)₆]³⁻, [Ag(S₂O₃)₂]³⁻, [Fe(CN)₆]⁴⁻, CO₃²⁻, SO₄²⁻ and SeO₄²⁻,
   whereby
   the ratio of the mixture of A1 and A2 is 1 mol [trivalent metal ion M^{III}]=(1 mol [A1]/valence of A1)+(1 mol [A2]/valence of A2),
   n is 1 to 4,
      x is the mole fraction having a value ranging from 0.1 to 0.5 and
      y is a value ranging from 0 to 5.0,
b) combining the solid particles and water with the oil in the oil-reservoir,
c) mixing the components of step b) to obtain an emulsion containing droplets, wherein the emulsion comprises the solid-particles, water and oil,
d) transferring the emulsion out of the oil-reservoir, and
e) recovering the solid particles of the emulsion.

The object of the present invention is achieved by a process for recovering oil from an oil-reservoir comprising at least the steps of:
a) providing solid particles and water,
   whereby the solid particles comprise at least one layered double hydroxide of general formula (I)

[M^{II}₍₁₋ₓ₎M^{III}ₓ(OH)₂]^{x+}[Aⁿ⁻]_{x/n}.y H₂O (I),
wherein
   M^{II} denotes a divalent metal ion or 2 Li,
   M^{III} denotes a trivalent metal ion,
   Aⁿ⁻ denotes at least one n-valent anion comprising:
      (i) a mixture of A1 and A2, or
      (ii) A1,
      whereby
      A1 is selected from the group consisting of alkyl sulfate, alkyl phosphate, alkyl sulfonate, alkyl carboxylate, alkyl phosphonate, alkyl phosphinate and alkyl carbonate, and
      A2 is selected from the group consisting of COO⁻, C₂O₄²⁻, H⁻, F⁻, Cl⁻, Br⁻, I⁻, OH⁻, CN⁻, NO₃⁻, NO₂⁻, ClO⁻, ClO₂⁻, ClO₃⁻, ClO₄⁻, MnO₄⁻, CH₃COO⁻, HCO₃⁻, H₂PO₄⁻, HSO₄⁻, HS⁻, SCN⁻, [Al(OH)₄]⁻, [Al(OH)₄(H₂O)₂]⁻, [Ag(CN)₂]⁻, [Cr(OH)₄]⁻, [AuCl₄]⁻, O²⁻, S²⁻, O₂²⁻, SO₃²⁻, S₂O₃²⁻, CrO₄²⁻, Cr₂O₇²⁻, HPO₄²⁻, [Zn(OH)₄]²⁻, [Zn(CN)₄]²⁻, [CuCl₄]²⁻, PO₄³⁻, [Fe(CN)₆]³⁻, [Ag(S₂O₃)₂]³⁻, [Fe(CN)₆]⁴⁻, CO₃²⁻, SO₄²⁻ and SeO₄²⁻,
whereby
the ratio of the mixture of A1 and A2 is 1 mol [trivalent metal ion M^{III}]=(1 mol [A1]/valence of A1)+(1 mol [A2]/valence of A2),
n is 1 to 4,
   x is the mole fraction having a value ranging from 0.1 to 0.5 and
   y is a value ranging from 0 to 5.0,
b) combining the solid particles and water with the oil in the oil-reservoir,
c) mixing the components of step b) to obtain an emulsion containing droplets, wherein the emulsion comprises the solid-particles, water and oil,
d) transferring the emulsion out of the oil-reservoir, and
e) recovering the solid particles of the emulsion.

In another embodiment, the presently claimed invention is directed to a process for recovering oil from an oil-reservoir comprising at least the steps of:
a) providing solid particles and water,
   whereby the solid particles comprise at least one layered double hydroxide of general formula (I)

[M^{II}₍₁₋ₓ₎M^{III}ₓ(OH)₂]^{x+}[Aⁿ⁻]_{x/n}.y H₂O (I),
wherein
   M^{II} denotes a divalent metal ion or 2 Li,
   M^{III} denotes a trivalent metal ion,
   Aⁿ⁻ denotes at least one n-valent anion comprising:
      (i) a mixture of A1 and A2, or
      (ii) A1,
      whereby
      A1 is selected from the group consisting of alkyl sulfate, alkyl phosphate, alkyl sulfonate, alkyl carboxylate, alkyl phosphonate, alkyl phosphinate and alkyl carbonate, and
      A2 is selected from the group consisting of COO⁻, C₂O₄²⁻, F⁻, Cl⁻, Br⁻, I⁻, OH⁻, CN⁻, NO₃⁻, NO₂⁻, ClO⁻, ClO₂⁻, ClO₃, ClO₄⁻, MnO₄⁻, CH₃COO⁻, HCO₃⁻, H₂PO₄, HSO₄⁻, HS⁻, SCN⁻, [Al(OH)₄]⁻, [Al(OH)₄(H₂O)₂]⁻, [Ag(CN)₂]⁻, [Cr(OH)₄]⁻, [AuCl₄]⁻, SO₃²⁻, S₂O₃²⁻, CrO₄²⁻, Cr₂O₇²⁻, HPO₄²⁻, [Zn(OH)₄]²⁻, [Zn(CN)₄]²⁻, [CuCl₄]²⁻, PO₄³⁻, [Fe(CN)₆]³⁻, [Ag(S₂O₃)₂]³⁻, [Fe(CN)₆]⁴⁻, CO₃²⁻, SO₄²⁻ and SeO₄²⁻,
whereby
the ratio of the mixture of A1 and A2 is 1 mol [trivalent metal ion M^{III}]=(1 mol [A1]/valence of A1)+(1 mol [A2]/valence of A2),
n is 1 to 4,
   x is the mole fraction having a value ranging from 0.1 to 0.5 and
   y is a value ranging from 0 to 5.0,
b) combining the solid particles and water with the oil in the oil-reservoir,
c) mixing the components of step b) to obtain an emulsion containing droplets, wherein the emulsion comprises the solid-particles, water and oil,
d) transferring the emulsion out of the oil-reservoir, and
e) recovering the solid particles of the emulsion.

### BRIEF DESCRIPTION OF THE FIGURES

FIG. 1 is a SEM image and shows that the product is a disk shaped material with the diameter of around 50 nm, the thickness of 10-20 nm, and the aspect ratio of 2.5-5.

FIG. 2 is a SEM image and shows that the product is a disk shaped material with the diameter of 30-180 nm, the thickness of around 15 nm, and aspect ratio of 2-12.

An alkyl (for Aⁿ⁻) can be a linear or branched, substituted or unsubstituted C₁-C₂₀-alkyl optionally interrupted by at least one heteroatom, at least partly halogenated, and/or at least partly hydroxylated, a linear or branched, substituted or unsubstituted C₄-C₁₈-alkyl optionally interrupted by at least one heteroatom, a substituted or unsubstituted C₃-C₂₀-cycloalkyl optionally attached via a linear or branched C₁-C₂₀-alkyl chain. An alkyl can be a linear or branched, substituted or unsubstituted, at least monounsaturated C₂-C₂₀-alkyl optionally interrupted by at least one heteroatom, and/or at least with one double bond in the alkyl chain.

Heteroatoms usable in accordance with the invention are selected from N, O, P and S.

Preferably, A2 is selected from the group consisting of C₂O₄²⁻, F⁻, Cl⁻, Br⁻, I⁻, OH⁻, NO₃⁻, ClO₄⁻, HPO₄²⁻, [Fe(CN)₆]³⁻, [Fe(CN)₆]⁴⁻, CO₃²⁻ and SO₄²⁻. More preferably A2 is selected from the group consisting of Cl⁻, Br, OH⁻, NO₃⁻, CO₃²⁻ and SO₄²⁻.

Preferably an alkyl is a linear or branched, substituted or unsubstituted C₁-C₂₀-alkyl, more preferably C₈-C₁₈-alkyl chain. In particular, an alkyl is a linear, unsubstituted C₁₄-C₁₈-alkyl, more particular a linear, unsubstituted C₁₆-alkyl.

An emulsion according to the present invention is a heterogeneous liquid system involving two immiscible phases, with one of the phases being intimately dispersed in the form of droplets in the second phase. The matrix of an emulsion is called the external or continuous phase, while the portion of the emulsion that is in the form of droplets is called the internal, dispersed or discontinuous phase.

An emulsion according to the present invention can also be denoted as a fluid colloidal system in which liquid droplets and/or liquid crystals are dispersed in a liquid. The droplets often exceed the usual limits for colloids in size. An emulsion is denoted by the symbol O/W (or o/w), if the continuous phase is an aqueous solution and by W/O or (w/o), if the continuous phase is an organic liquid (an “oil”). More complicated emulsions such as O/W/O (i. e. oil droplets contained within aqueous droplets dispersed in the continuous oil phase) are also possible.

Preferably, the inventive emulsion is a o/w emulsion.

Apart from the conventional emulsions in which surface-active substances stabilize the emulsion, it is also possible to stabilize emulsion by solids.

The term “stability” or “stabilized” for an emulsion refers to the period up to incipient separation, and in which the emulsion does not visually show segregation, such as the formation of a visible bottom layer of water and/or a visible top layer of oil.

The term “valence” refers to the charge of A1 or A2. For example, the valence of CH₃COO⁻ is −1.

For evaluating the stability, as used in this invention, a test method is to be used wherein a sample of 100 g of emulsion is stored in a test tube with an inner diameter of 2.5 cm and sufficient length. The tube is stored at a selected temperature and monitored over time for separation to occur, i.e. for formation of a top or bottom layer. The stability is then the time elapsing between filling the test tube and the observation of the separation phenomenon. The temperature is to be chosen such that it is above the melting temperature of the compound in the emulsions with the highest melting temperature, and below the boiling temperature of the lowest boiling compound of the emulsion. Suitably it is chosen between 30° C. and 300° C.

These solid stabilized emulsions are characterized by the stabilization of the phase boundary with the help of (nano)particulate solid particles. These solids are not surface-active but form a mechanical barrier around the droplets of the internal phase and thus prevent their coalescence. In contrast to conventional emulsions, the use of emulsifiers is normally not necessary.

According to the IUPAC definition, emulsifiers are surfactants that stabilize emulsions by lowering the rate of aggregation and/or coalescence of the emulsions. Surface-active substances are located primarily in the interface between the oil and water phase to lower the interfacial tension.

The term “solid” means a substance in its most highly concentrated form, i.e., the atoms or molecules comprising the substance are more closely packed with one another relative to the liquid or gaseous states of the substance.

The “particle” of the present invention can have any shape, for example a spherical, cylindrical, acicular or cuboidal shape.

“Oil” means a fluid containing a mixture of condensable hydrocarbons of more than 90 wt.-%, preferably of more than 99 wt.-%. In particular “oil” can be defined as a mixture consisting of condensable hydrocarbons.

Preferably, the oil used for making the solid particles-stabilized emulsion can contain a sufficient amount of asphaltenes, polar hydrocarbons, or polar resins to help stabilize the solid particles-oil interaction.

“Hydrocarbons” are organic material with molecular structures containing carbon and hydrogen. Hydrocarbons may also include other elements, such as, but not limited to, halogens, metallic elements, nitrogen, oxygen, and/or sulfur.

A “mixture of A1 and A2” means that at least an anion A1 and an anion A2 are present in the at least one layered double hydroxide of general formula (I) (LDH). A1 and A2 are separate anions in the LDH, which can replace each other in the interlayer region of the LDH. In other words, the LDH can have two different anions located in the interlayer region. Preferably, Aⁿ⁻ denotes two anions. In order to maintain charge balance, the sum of the molar number of A1 divided by the valence of A1 and the molar number of A2 divided by the valence of A2 should be same as the molar number of trivalent metal ion, i.e. the ratio of the mixture of A1 and A2 is 1 mol [trivalent metal ion M^{III}]=(1 mol [A1]/valence of A1)+(1 mol [A2]/valence of A2).

Layered double hydroxides of general formula (I) (LDH) comprise an unusual class of layered materials with positively charged layers and charge balancing anions located in the interlayer region. This is unusual in solid state chemistry: many more families of materials have negatively charged layers and cations in the interlayer spaces (e.g. kaolinite, Al₂Si₂O₅(OH)₄).

Preferably the at least one layered double hydroxide is represented by the general formula (I)

[M^{II}₍₁₋ₓ₎M^{III}ₓ(OH)₂]^{x+}[Aⁿ⁻]_{x/n}.y H₂O (I),
wherein
M^{II} denotes a divalent metal ion or 2 Li,
M^{III} denotes a trivalent metal ion,
Aⁿ⁻ denotes at least one n-valent anion comprising:
   (i) a mixture of A1 and A2, or
   (ii) A1,
   whereby
   A1 is selected from the group consisting of alkyl sulfate, alkyl phosphate, alkyl sulfonate, alkyl carboxylate, alkyl phosphonate, alkyl phosphinate and alkyl carbonate, and
   A2 is selected from the group consisting of H⁻, F⁻, Cl⁻, Br⁻, I⁻, OH⁻, CN⁻, NO₃⁻, NO₂⁻, ClO⁻, ClO₂⁻, ClO₃⁻, ClO₄⁻, MnO₄⁻, CH₃COO⁻, HCO₃⁻, H₂PO₄⁻, HSO₄⁻, HS⁻, SCN⁻, [Al(OH)₄]⁻, [Al(OH)₄(H₂O)₂]⁻, [Ag(CN)₂]⁻, [Cr(OH)₄]⁻, [AuCl₄]⁻, O²⁻, S²⁻, O₂²⁻, SO₃²⁻, S₂O₃²⁻, CrO₄²⁻, Cr₂O₇²⁻, HPO₄²⁻, [Zn(OH)₄]²⁻, [Zn(CN)₄]²⁻, [CuCl₄]²⁻, PO₄³⁻, [Fe(CN)₆]³⁻, [Ag(S₂O₃)₂]³⁻, [Fe(CN)₆]⁴⁻, CO₃²⁻, SO₄²⁻ and SeO₄²⁻,
whereby
the ratio of the mixture of A1 and A2 is 1 mol [trivalent metal ion M^{III}]=(1 mol [A1]/valence of A1)+(1 mol [A2]/valence of A2),
n is 1 to 4,
x is the mole fraction having a value ranging from 0.1 to 0.5 and
y is a value ranging from 0 to 5.0.

Preferably x is the mole fraction having a value ranging from 0.2 to 0.33. More preferably, x having a value ranging from 0.2 to 0.33 and y having a value ranging from 0.1 to 4.0.

The layered double hydroxide (LDH) of general formula (I) according to the present invention can be obtained by the reaction of a layered double hydroxide of general formula (IA) and the salt of an alkyl sulfate, alkyl phosphate, alkyl sulfonate, alkyl carboxylate, alkyl phosphonate, alkyl phosphinate and alkyl carbonate, whereby the cation is selected from alkali metals, alkaline earth metals and rare earth metals or mixtures thereof.

Preferably the LDH of formula (I) can be obtained by mixing, for example by sonication, the salt of an alkyl sulfate, alkyl phosphate, alkyl sulfonate, alkyl carboxylate, alkyl phosphonate, alkyl phosphinate and alkyl carbonate, whereby the cation is selected from alkali metals, alkaline earth metals and rare earth metals or mixtures thereof and a layered double hydroxide of general formula (IA), optional in the presence of an acid. In particular the acid can be HNO₃.

Examples of the at least one layered double hydroxide of general formula (IA) include hydrotalcite [Mg₆Al₂(CO₃)(OH)₁₆.4(H₂O)], manasseite [Mg₆Al₂(CO₃)(OH)₁₆.4(H₂O)], pyroaurite [Mg₆Fe₂(CO₃)(OH)₁₆.4.5(H₂O)], sjoegrenite [Mg₆Fe₂(CO₃)(OH)₁₆.4.5(H₂O)], stichtite [Mg₆Cr₂(CO₃)(OH)₁₆.4(H₂O)], barbertonite [Mg₆Cr₂(CO₃)(OH)₁₆.4(H₂O)], takovite, reevesite [Ni₆Fe₂(CO₃)(OH)₁₆.4(H₂O)], desautelsite [Mg₆Mn₂(CO₃)(OH)₁₆CO₃.4(H₂O)], motukoreaite, wermlandite, meixnerite, coalingite, chlormagalunninite, carrboydite, honessite, woodwardite, iowaite, hydrohonessite and mountkeithite. More preferably the at least one layered double hydroxide of general formula (I) is selected from the group consisting of hydrotalcite [Mg₆Al₂(CO₃)(OH)₁₆.4(H₂O)], manasseite [Mg₆Al₂(CO₃)(OH)₁₆.4(H₂O)], pyroaurite [Mg₆Fe₂(CO₃)(OH)₁₆.4.5(H₂O)], sjoegrenite [Mg₆Fe₂(CO₃)(OH)₁₆.4.5(H₂O)], stichtite [Mg₆Cr₂(CO₃)(OH)₁₆.4(H₂O)], barbertonite [Mg₆Cr₂(CO₃)(OH)₁₆.4(H₂O)], takovite, reevesite [Ni₆Fe₂(CO₃)(OH)₁₆.4(H₂O)] and desautelsite [Mg₆Mn₂(CO₃)(OH)₁₆CO₃.4(H₂O)]. More preferably the at least one layered double hydroxide is selected from the group consisting of hydrotalcite [Mg₆Al₂(CO₃)(OH)₁₆.4(H₂O)], manasseite [Mg₆Al₂(CO₃)(OH)₁₆.4(H₂O)], pyroaurite [Mg₆Fe₂(CO₃)(OH)₁₆.4.5(H₂O)] and sjoegrenite [Mg₆Fe₂(CO₃)(OH)₁₆.4.5(H₂O)].

In step a) according to the present invention, solid particles and water are provided whereby the solid particles comprise at least one layered double hydroxide of general formula (I). Preferably the solid particles and water are combined, for example as a suspension.

The solid particles are added in an amount that is sufficient to stabilize an oil-in-water emulsion. Preferably, the solid particles can be added in an amount of 0.01 to 10 g in relation to 100 ml water, more preferably in amount of 0.01 to 5.0 g in relation to 100 ml water, most preferably in an amount of 0.01 to 2.5 g in relation to 100 ml water, i.e. water containing preferably 0.01 to 10 weight-%, more preferably 0.01 to 5.0 weight-%, most preferably 0.01 to 2.5 weight-% solid particles is added.

In step b) according to the present invention, the solid particles and water are combined with the oil in the oil reservoir. Preferably, the solid particles and the water can be combined with the oil by a supply line. In the supply line the water and the solid particles can be mixed. The supply line can be a (well)bore, a tube or a channel. Preferably, the solid particles and the water are pressed into the oil reservoir by a specified pressure. The specified pressure is a function of the permeability times the thickness of the reservoir layer divided by the viscosity of the injection fluid. The total pressure should not exceed the fracturing pressure of the rock matrix.

The term “(well)bore” refers to a hole in a formation made by drilling or insertion of a conduit into the formation. A wellbore may have a substantially circular cross section, or other cross-sectional shapes (e.g., circles, ovals, squares, rectangles, triangles, slits, or other regular or irregular shapes). As used herein, the terms “well” and “opening,” when referring to an opening in the formation may be used interchangeably with the term “(well)bore.”

In step c) according to the present invention, the components of step b) are mixed to obtain an emulsion containing droplets, wherein the emulsion comprises solid particles, water and oil. For example, the mixing can be based on the pressure applied in step b) causing a flow in the oil-reservoir. In this region an emulsion can be formed. The emulsion can be prepared by dispersion of the water phase in the oil phase with the help of the solid particles. Emulsification is effected by a sufficient amount of mixing energy which results from the shear in the oil reservoir, for example an oil-containing formation. The oil-containing sandstone formation can be a subterranean oil-containing formation The mixing can be effected by the flow of the fluids through the oil reservoir, whereby the oil reservoir can be a subterranean oil containing formation. The subterranean oil containing formation can contain porous rocks. In other words, mixing is naturally accomplished by flow of the fluids through the porous rocks.

In step d) the emulsion is transferred out of the oil reservoir. The transfer of the emulsion out of the oil reservoir can be carried out in an outlet line. The outlet line can be a (well)bore, a tube or a channel. Preferably, the outlet line is different from the inlet line. The expression “(well)bore” has the same meaning as explained above. The emulsion can be transferred to a surface facility. A surface facility means any facility configured to receive production fluids. The facility may be at or near the wellhead, or may be downstream. The facility may be on land, on a floating platform, or on a vessel.

In step e) according to the present invention the solid particles of the emulsion are recovered. Preferably, the emulsion is supplied to a separator unit. In this separator unit the emulsion can be broken for example by applying energy, chemical compounds, or a magnetic field. The separator unit can be connected to the outlet line. In this step, the solid particles, the water and the at least one oil can be recovered.

In order to separate the oil and water, the oil-in-water emulsion is treated with chemicals. These chemicals are referred to as dehydration chemicals or demulsifiers. Demulsifiers allow the dispersed droplets of the emulsion to coalesce into larger drops and settle out of the matrix. For example, U.S. Pat. No. 5,045,212; U.S. Pat. No. 4,686,066; and U.S. Pat. No. 4,160,742 disclose examples of chemical demulsifiers used for breaking emulsions. In addition, commercially available chemical demulsifiers, such as ethoxylated-propoxylated phenolformaldehyde resins and ethoxylated-propoxylated alcohols, are known for demulsification of crude oils. Such demulsifiers further minimize the amount of heat and settling time otherwise required for separation. However, the effectiveness of these demulsifiers on heavy crude oils, particularly those containing asphaltenes, naphthenic acids and inorganic solids may be limited.

Where the oil is heavy oil, it is typical to also employ electrostatic separators. Gravity settling and centrifugation in conjunction with chemical demulsifiers have also been employed. It is also a known practice to increase the temperature of operation of separators in an attempt to break water/oil emulsions. U.S. Pat. No. 4,938,876 discloses a method for separating oil, water and solids from emulsions by heating the emulsion to about 115° C., rapidly cooling the mixture to below 100° C., separating the solids from the liquids and then separating the water from the oil. The patent further discloses the addition of a flocculant prior to cooling the mixture.

In some known technologies for breaking emulsions, an intermediate emulsion rag layer is produced. Further processing of the rag layer may be utilized to recover the oil and discharge the water. Recently, a microwave technology has been disclosed in U.S. Pat. No. 6,086,830 and U.S. Pat. No. 6,077,400. This microwave technology uses microwaves to treat hard-to-treat emulsions, especially for the rag layer.

As the emulsion, especially the solid particles-stabilized emulsion, has a low viscosity, this emulsion is not used
(a) as drive fluids to displace oils too viscous to be recovered efficiently by waterflooding in non-thermal (or “cold flow”) or thermal applications;
(b) to fill high permeability formation zones for “profile modification” applications to improve subsequent waterflood performance;
(c) to form effective horizontal barriers to vertical flow of water or gas to reduce coning of the water or gas to the oil producing zone of a well.

The emulsion contains droplets, whereby water can be the continuous phase and oil can be the dispersed phase, i.e. an oil-in-water emulsion is formed in the oil-containing formation. Preferably the oil-in-water emulsion is formed at a temperature in the range of 30 to 200° C., more preferably in the range of 40 to 150° C., most preferably in the range of 50 to 100° C. Emulsification can be effected by a sufficient amount of mixing energy which results from the shear in the oil-containing formation. In other words, mixing can be naturally accomplished by flow of the fluids through the porous rocks.

The present invention is further elucidated by way of the following embodiments and preferred embodiments. They may be combined freely unless the context clearly indicates otherwise.

Preferably, the inventive process for recovering oil from an oil-reservoir consisting of the steps:
a) providing solid particles and water,
   whereby the solid particles comprise at least one layered double hydroxide of general formula (I)

[M^{II}₍₁₋ₓ₎M^{III}ₓ(OH)₂]^{x+}[Aⁿ⁻]_{x/n}.y H₂O (I),
wherein
   M^{II} denotes a divalent metal ion or 2 Li,
   M^{III} denotes a trivalent metal ion,
   Aⁿ⁻ denotes at least one n-valent anion comprising:
      (i) a mixture of A1 and A2, or
      (ii) A1,
      whereby
      A1 is selected from the group consisting of alkyl sulfate, alkyl phosphate, alkyl sulfonate, alkyl carboxylate, alkyl phosphonate, alkyl phosphinate and alkyl carbonate, and
      A2 is selected from the group consisting of H⁻, F⁻, Cl⁻, Br⁻, I⁻, OH⁻, CN⁻, NO₃⁻, NO₂⁻, ClO⁻, ClO₂⁻, ClO₃⁻, ClO₄⁻, MnO₄⁻, CH₃COO⁻, HCO₃⁻, H₂PO₄⁻, HSO₄⁻, HS⁻, SCN⁻, [Al(OH)₄]⁻, [Al(OH)₄(H₂O)₂]⁻, [Ag(CN)₂]⁻, [Cr(OH)₄]⁻, [AuCl₄]⁻, O²⁻, S²⁻, O₂²⁻, SO₃²⁻, S₂O₃²⁻, CrO₄²⁻, Cr₂O₇²⁻, HPO₄²⁻, [Zn(OH)₄]²⁻, [Zn(CN)₄]²⁻, [CuCl₄]²⁻, PO₄³⁻, [Fe(CN) 6]³⁻, [Ag(S₂O₃)₂]³⁻, [Fe(CN)₆]⁴⁻, CO₃²⁻, SO₄²⁻ and SeO₄²⁻,
whereby
the ratio of the mixture of A1 and A2 is 1 mol [trivalent metal ion M^{III}]=(1 mol [A1]/valence of A1)+(1 mol [A2]/valence of A2),
   n is 1 to 4,
   x is the mole fraction having a value ranging from 0.1 to 0.5 and
   y is a value ranging from 0 to 5.0,
b) combining the solid particles and water with the oil in the oil-reservoir,
c) mixing the components of step b) to obtain an emulsion containing droplets, wherein the emulsion comprises the solid-particles, water and oil,
d) transferring the emulsion out of the oil-reservoir, and
e) recovering the solid particles of the emulsion.

In particular, the inventive process for recovering oil from an oil-reservoir comprising at least the steps:
a) providing solid particles and water,
   whereby the solid particles comprise at least one layered double hydroxide of general formula (I)

[M^{II}₍₁₋ₓ₎M^{III}ₓ(OH)₂]^{x+}[Aⁿ⁻]_{x/n}.y H₂O (I),
wherein
   M^{II} denotes a divalent metal ion or 2 Li,
   M^{III} denotes a trivalent metal ion,
   Aⁿ⁻ denotes at least one n-valent anion comprising:
      (i) a mixture of A1 and A2, or
      (ii) A1,
      whereby
      A1 is selected from the group consisting of alkyl sulfate and alkyl phosphate, and
      A2 is CO₃²⁻,
      whereby
the ratio of the mixture of A1 and A2 is 1 mol [trivalent metal ion M^{III}]=(1 mol [A1]/valence of A1)+(1 mol [A2]/valence of A2),
   n is 1 or 2,
   x is the mole fraction having a value ranging from 0.1 to 0.5 and
   y is a value ranging from 0 to 5.0,
b) combining the solid particles and water with the oil in the oil-reservoir,
c) mixing the components of step b) to obtain an emulsion containing droplets, wherein the emulsion comprises the solid-particles, water and oil,
d) transferring the emulsion out of the oil-reservoir, and
e) recovering the solid particles of the emulsion.

More particular, the inventive process for recovering oil from an oil-reservoir consisting of the steps:
a) providing solid particles and water,
   whereby the solid particles comprise at least one layered double hydroxide of general formula (I)

[M^{II}₍₁₋ₓ₎M^{III}ₓ(OH)₂]^{x+}[Aⁿ⁻]_{x/n}.y H₂O (I),
wherein
   M^{II} denotes a divalent metal ion or 2 Li,
   M^{III} denotes a trivalent metal ion,
   Aⁿ⁻ denotes at least one n-valent anion consisting of:
      (i) a mixture of A1 and A2, or
      (ii) A1,
      whereby
      A1 is selected from the group consisting of alkyl sulfate and alkyl phosphate, and
      A2 is CO₃²⁻,
      whereby
the ratio of the mixture of A1 and A2 is 1 mol [trivalent metal ion M^{III}]=1 mol [A1]/valence of A1)+(1 mol [A2]/valence of A2),
   n is 1 or 2,
   x is the mole fraction having a value ranging from 0.1 to 0.5 and
   y is a value ranging from 0 to 5.0,
b) combining the solid particles and water with the oil in the oil-reservoir,
c) mixing the components of step b) to obtain an emulsion containing droplets, wherein the emulsion comprises the solid-particles, water and oil,
d) transferring the emulsion out of the oil-reservoir, and
e) recovering the solid particles of the emulsion.

Preferably, the divalent metal ion is Ca, Mg, Fe, Ni, Zn, Co, Cu or Mn and the trivalent metal ion is Al, Fe, Cr or Mn, more preferably, the divalent metal ion is Mg or Fe and the trivalent metal ion is Al or Fe.

In a preferred embodiment of the inventive process the oil-reservoir is a subterranean oil-containing formation.

In a preferred embodiment of the inventive process, the emulsion is a solid particles-stabilized emulsion. Preferably, the emulsion consists of water, at least one oil, and solid particles, whereby the solid particles comprise at least one layered double hydroxide of general formula (I). A solid particles-stabilized emulsion according to the present invention is an emulsion that is stabilized by solid particles which adsorb onto the interface between two phases, for example an oil phase and a water phase.

In a preferred embodiment of the inventive process, A1 is selected from the group consisting of alkyl sulfate and alkyl phosphate and A2 is selected from the group consisting of CO₃²⁻ and Cl⁻.

In a preferred embodiment of the inventive process, A1 is an alkyl sulfate selected from the group consisting of octyl sulfate, decyl sulfate, dodecyl sulfate, tetradecyl sulfate, hexadecyl sulfate and octadecyl sulfate. Preferably, A1 is an alkyl sulfate selected from the group consisting of tetradecyl sulfate, hexadecyl sulfate and octadecyl sulfate. More preferably, A1 is hexadecyl sulfate.

In a preferred embodiment of the inventive process the emulsion comprises 9.9 to 90.0% by weight water, 10.0 to 90.0% by weight oil and 0.1 to 10.0% by weight of at least one layered double hydroxide of general formula (I) related to the overall weight of the emulsion. Preferably, the emulsion comprises 49.9 to 90.0% by weight water, 10.0 to 50.0% by weight oil and 0.1 to 5.0% by weight of at least one layered double hydroxide of general formula (I), most preferably 69.9 to 90.0% by weight water, 10.0 to 30.0% by weight oil and 0.1 to 2.5% by weight of at least one layered double hydroxide of general formula (I), in each case related to the overall weight of the emulsion.

In a preferred embodiment of the inventive process the solid particles are delaminated by the treatment with an alcohol at a temperature in the range from 50° C. to 100° C. for 1 h to 30 h. Preferably, the solid particles are delaminated by the treatment with alcohol at a temperature in the range from 60° C. to 90° C. for 5 to 25 h, in particular, the solid particles are delaminated at a temperature in the range from 60° C. to 80° C. for 15 h to 25 h. Preferably the delamination can be carried out after step c) and before step d) or after step b) and before d). More preferably, the delamination can be carried out after step b) and before step d). Delamination means to separate the two layers of a LDH into two separate layers. Therefore, the anions are contained in both separate layers. Preferably, the alcohol is an C₁-C₆-alcohol, more preferably butanol.

In a preferred embodiment of the inventive process the oil is crude oil.

Most preferably the oil is crude oil having an API gravity in the range between 20° API and 40° API. Such oils, by nature of their composition, usually contain asphaltenes and polar hydrocarbons. API gravity is defined as following formula by the American Petroleum Institute: API gravity=(141.5/Specific Gravity)−131.5, where specific gravity is a ratio of the density of oil to the density of a reference substance, usually water, and is always determined at 60 degrees Fahrenheit.

“Crude oil” is defined as a mixture of hydrocarbons that existed in liquid phase in underground reservoirs and remains liquid at atmospheric pressure after passing through surface separating facilities and which has not been processed through a crude oil distillation tower.

The emulsions disclosed herein are preferably used to recover crude oil. Such oils, by nature of their composition, usually contain sufficient asphaltenes and polar hydrocarbons, which will help stabilize the solid particles-stabilized emulsion.

In a preferred embodiment of the inventive process the emulsion has a viscosity at 20° C. in the range of 5 to 30 mPa·s under shear rate of 10/s according to ISO 13320. More preferably, the emulsion has a viscosity in the range of 5 to 20 mPa·s under shear rate of 10/s determined according to DIN 53019.

The solid particles are made of layered double hydroxide of general formula (I). The actual average particle size should be sufficiently small to provide adequate surface area coverage of the internal oil phase.

In a preferred embodiment of the process according to the present invention the solid particles have an average particle size in the range of 30 nm to 10 μm determined according to SEM. More preferably, the solid particles have an average particle size in the range of 30 nm to 2 μm and most preferably in the range of 50 nm to 100 nm, determined according to SEM images (as defined under Method A).

Preferably, the aspect ratio of the solid particles which are made of layered double hydroxide of general formula (I) is in the range of 1 to 30, more preferably in the range of 1 to 20, most preferably in the range of 1 to 10, even more preferably in the range of 2 to 8, whereby the aspect ratio is defined as diameter/thickness. The diameter and the thickness are determined according to SEM images (as defined under Method A).

Preferably, the solid particles have a BET surface area in the range of 50 to 400 m²/g, more preferably in the range of 80 to 130 m²/g, according to DIN 66131: 1993-06 at 77 K.

Preferably, the solid particles remain undissolved in the water phase under the inventively used conditions, but have appropriate charge distribution for stabilizing the interface between the internal droplet phase, i.e. oil, and the external continuous phase, i.e. water, to make a solid particles-stabilized oil-in-water emulsion.

Preferably, the solid particles are hydrophilic for making an oil-in-water emulsion. Thereby, the particles are properly wetted by the continuous phase, i. e. water that holds the discontinuous phase. The appropriate hydrophilic character may be an inherent characteristic of the solid particles or either enhanced or acquired by treatment of the solid particles.

In the scope of the present invention, “hydrophilic” means that the surface of a corresponding “hydrophilic” solid particle has a contact angle with water against air of <90°. The contact angle is determined according to methods that are known to the skilled artisan, for example using a standard-instrument (Dropshape Analysis Instrument, Fa. Kruss DAS 10). A shadow image of the droplet is taken using a CCD-camera, and the shape of the droplet is acquired by computer aided image analysis. These measurements are conducted according to DIN 5560-2.

In a preferred embodiment of the inventive process the droplets of the emulsion have an average droplet size Dv₅₀ in the range of 1 to 13 μm determined according to ISO13320: 2010-01.

Preferably the droplets of the emulsion have an average droplet size Dv₅₀ in the range of 2 to 10 μm and most preferably in the range of 3 to 8 μm, determined according to ISO13320: 2010-01. Dv₅₀ is defined as the volume median diameter at which 50% of the distribution is contained in droplets that are smaller than this value while the other half is contained in droplets that are larger than this value.

Preferably the droplets that are present in the oil-in-water emulsion have an average droplet size Dv₉₀ in the range of 10 to 40 μm, more preferably in the range of 12 to 30 μm and most preferably in the range of 14 to 20 μm, determined according to ISO13320:2010-01. Dv₉₀ is defined as the diameter at which 90% of the distribution is contained in droplets that are smaller than this value while 10% is contained in droplets that are larger than this value.

Preferably the emulsion can contain surfactants. The surfactant can be an anionic, zwitterionic or amphoteric, nonionic or cationic surfactant, or a mixture of two or more of these surfactants. Examples of suitable anionic surfactants include carboxylates, sulfates, sulfonates, phosphonates, and phosphates. Examples of suitable nonionic surfactants include alcohol ethoxylates, alkyl phenol ethoxylates, fatty acid ethoxylates, sorbitan esters and their ethoxylated derivatives, ethoxylated fats and oils, amine ethoxylates, ethylene oxide-propylene oxide copolymers, surfactants derived from mono- and polysaccharides such as the alkyl polyglucosides, and glycerides. Examples of suitable cationic surfactants include quaternary ammonium compounds. Examples of zwitterionic or amphoteric surfactants include N-alkyl betaines or other surfactants derived from betaines.

Preferably, the water used for making the solid particles-stabilized emulsion contains ions. Preferably, the total ion concentration is in the range of 3000 to 300 000 mg/I, more preferably the total ion concentration is in the range of 150 000 to 250 000 mg/I, most preferably the total ion concentration is in the range of 160 000 to 200 000 mg/I. Water having an ion concentration in the range of 3000 to 300 000 mg/I is referred to as salt water in the sense of the presently claimed invention.

Preferably, the water used for making the solid particles-stabilized emulsion has conductivity in the range of 8 mS/cm to 300 mS/cm, more preferably in the range of 54 mS/cm to 300 mS/cm, most preferably in the range of 150 to 250 mS/cm.

The conductivity is a measure of the level of ion concentration of a solution. The more salts, acids or bases are dissociated, the greater the conductivity of the solution. In water or wastewater it is mainly a matter of the ions of dissolved salts, and consequently the conductivity is an index of the salt load in water. The measurement of conductivity is generally expressed in S/cm (or mS/cm) which is the product of the conductance of the test solution and the geometric factor of the measuring cell. Conductivity can be measured using a variety of commercially available test instruments such as the Waterproof PC 300 hand-held meter made by Eutech Instruments/Oakton Instruments.

In a preferred embodiment of the inventive process the subterranean oil-containing formation has pores and the emulsion is obtained by transporting the solid particles and water through these pores. In particular, the emulsion is obtained in step c) of the present invention by transporting the solid particles and water through these pores.

The formations have an absolute permeability that is sufficiently high so that the pore throats are large enough to allow individual droplets to pass through the pores unimpeded. The lower limit on permeability is thus dependent not only on the rock pore structure, but also on the droplet size distribution in the emulsion. For most applications, rock permeability is not expected to be a limiting factor. For example, many formation rocks containing heavy oil deposits have an absolute permeability of from 3.0·10⁻¹³ to 1.5·10⁻¹¹ m². Such rocks have pore throats with average diameters of from 20 to 200 μm. Droplets sizes in emulsions formed in these rocks are ranging in diameters that are smaller the average diameter of the pore throats, thus the droplets should not be impeded in flow through such rocks.

The lower limit of rock permeability to allow flow of a specific solid particles-stabilized emulsion can be determined in laboratory tests by flowing said emulsion through a series of rocks of decreasing, but known, absolute permeability. Procedures for conducting such core flow tests are easily known to those skilled in the art, but involve measuring pressure drops across the core at measured flow rates and determining whether the emulsion is trapped within the rock pores or passes unimpeded through the rock. An exact lower limit for application of such solid particles-stabilized emulsions is determined to be below 1.5·10⁻¹¹ m² for emulsions having average droplet diameters Dv₅₀ of less than 5 μm. Such core flood tests conducted in rock representative of the target formation application are currently the best method for determining whether the droplet size distribution of the emulsion is sufficiently small to allow emulsion flow without trapping of droplets at pore throats.

In a preferred embodiment of the inventive process the oil has a viscosity in the range of 1 to 5000 mPa·s at a temperature of 20° C. according to DIN 53019-1:2008-09. Preferably, the oil has a viscosity in the range of 500 to 4000 mPa·s at a temperature of 20° C., more preferably a viscosity of 1000 to 3000 mPa·s at a temperature of 20° C. according to DIN 53019-1:2008-09.

In a preferred embodiment of the inventive process the divalent metal ion is Ca, Mg, Fe, Ni, Zn, Co, Cu or Mn, the trivalent metal ion is Al, Fe, Cr or Mn, A1 is an alkyl sulfate, and A2 is CO₃². Preferably, the divalent metal ion is Mg or Fe, the trivalent metal ion is Al or Fe, A1 is an alkyl sulfate, and A2 is CO₃²⁻.

In a preferred embodiment of the inventive process the emulsion has a conductivity in the range of 1 to 275 mS/cm. Preferably, the emulsion has a conductivity in the range from 10 to 260 mS/cm, more preferably in the range of 80 to 250 mS/cm. In particular, the conductivity in the range from 50 to 190 mS/cm can correspond to an overall concentration of the n-valent anion selected from the group consisting of alkyl sulfate and alkyl phosphate, alkyl sulfonate, alkyl carboxylate, alkyl phosphonate, alkyl phosphinate and alkyl carbonate at a concentration in the range from 5 to 100 mM.

In a preferred embodiment of the inventive process the aspect ratio of the solid particles is in the range from 1 to 30 determined according to SEM images. More preferably, the aspect ratio is in the range from 5 to 20.

In a preferred embodiment the inventively claimed process for recovering oil from an oil-reservoir comprises the steps of:
a) providing solid particles and water having conductivity in the range of 15 mS/cm to 300 mS/cm,
   whereby the solid particles comprise at least one layered double hydroxide of general formula (I)

[M^{II}₍₁₋ₓ₎M^{III}ₓ(OH)₂]^{x+}[Aⁿ⁻]_{x/n}.y H₂O (I),
wherein
   M^{II} denotes a divalent metal ion or 2 Li,
   M^{III} denotes a trivalent metal ion,
   Aⁿ⁻ denotes at least one n-valent anion comprising:
      (i) a mixture of A1 and A2, or
      (ii) A1,
      whereby
      A1 is selected from the group consisting of alkyl sulfate, alkyl phosphate, alkyl sulfonate, alkyl carboxylate, alkyl phosphonate, alkyl phosphinate and alkyl carbonate, and
      A2 is selected from the group consisting of H⁻, F⁻, Cl⁻, Br⁻, I⁻, OH⁻, CN⁻, NO₃⁻, NO₂⁻, ClO⁻, ClO₂⁻, ClO₃⁻, ClO₄⁻, MnO₄⁻, CH₃COO⁻, HCO₃⁻, H₂PO₄⁻, HSO₄⁻, HS⁻, SCN⁻, [Al(OH)₄]⁻, [Al(OH)₄(H₂O)₂]⁻, [Ag(CN)₂]⁻, [Cr(OH)₄]⁻, [AuCl₄]⁻, O²⁻, S²⁻, O₂²⁻, SO₃²⁻, S₂O₃²⁻, CrO₄²⁻, Cr₂O₇²⁻, HPO₄²⁻, [Zn(OH)₄]²⁻, [Zn(CN)₄]²⁻, [CuCl₄]²⁻, PO₄³⁻, [Fe(CN)₆]³⁻, [Ag(S₂O₃)₂]³⁻, [Fe(CN)₆]⁴⁻, CO₃²⁻, SO₄²⁻ and SeO₄²⁻,
whereby
the ratio of the mixture of A1 and A2 is 1 mol [trivalent metal ion M^{III}]=(1 mol [A1]/valence of A1)+(1 mol [A2]/valence of A2),
   n is 1 to 4,
   x is the mole fraction having a value ranging from 0.1 to 0.5 and
   y is a value ranging from 0 to 5.0,
b) combining the solid particles and water having conductivity in the range of 15 mS/cm to 300 mS/cm with the crude oil in the oil-reservoir,
c) mixing the components of step b) to obtain an emulsion containing droplets, wherein the emulsion comprises the solid-particles, water having conductivity in the range of 15 mS/cm to 300 mS/cm and crude oil,
d) transferring the emulsion out of the oil-reservoir, and
e) recovering the solid particles of the emulsion.

In a more preferred embodiment the inventively claimed process for recovering oil from an oil-reservoir comprises the steps of:
a) providing solid particles and water having conductivity in the range of 15 mS/cm to 300 mS/cm,
   whereby the solid particles comprise at least one layered double hydroxide of general formula (I)

[M^{II}₍₁₋ₓ₎M^{III}ₓ(OH)₂]^{x+}[Aⁿ⁻]_{x/n}.y H₂O (I),
wherein
   M^{II} denotes a divalent metal ion or 2 Li,
   M^{III} denotes a trivalent metal ion,
   Aⁿ⁻ denotes at least one n-valent anion comprising:
      (i) a mixture of A1 and A2, or
      (ii) A1,
      whereby
      A1 is selected from the group consisting of alkyl sulfate, alkyl phosphate, alkyl sulfonate, alkyl carboxylate, alkyl phosphonate, alkyl phosphinate and alkyl carbonate, and
      A2 is selected from the group consisting of F⁻, Cl⁻, Br⁻, I⁻, OH⁻, CN⁻, NO₃⁻, NO₂⁻, ClO⁻, ClO₂⁻, ClO₃⁻, ClO₄⁻, MnO₄⁻, CH₃COO⁻, HCO₃⁻, H₂PO₄⁻, HSO₄⁻, HS⁻, SCN⁻, [Al(OH)₄]⁻, [Al(OH)₄(H₂O)₂]⁻, [Ag(CN)₂]⁻, [Cr(OH)₄]⁻, [AuCl₄]⁻, SO₃²⁻, S₂O₃²⁻, CrO₄²⁻, Cr₂O₇²⁻, HPO₄²⁻, [Zn(OH)₄]²⁻, [Zn(CN)₄]²⁻, [CuCl₄]²⁻, PO₄³⁻, [Fe(CN)₆]³⁻, [Ag(S₂O₃)₂]³⁻, [Fe(CN)₆]⁴⁻, CO₃²⁻, SO₄²⁻ and SeO₄²⁻,
whereby
the ratio of the mixture of A1 and A2 is 1 mol [trivalent metal ion M^{III}]=(1 mol [A1]/valence of A1)+(1 mol [A2]/valence of A2),
   n is 1 to 4,
   x is the mole fraction having a value ranging from 0.1 to 0.5 and
   y is a value ranging from 0 to 5.0,
b) combining the solid particles and water having conductivity in the range of 15 mS/cm to 300 mS/cm with the crude oil in the oil-reservoir,
c) mixing the components of step b) to obtain an emulsion containing droplets, wherein the emulsion comprises the solid-particles, water having conductivity in the range of 15 mS/cm to 300 mS/cm and crude oil,
d) transferring the emulsion out of the oil-reservoir, and
e) recovering the solid particles of the emulsion.

In yet another preferred embodiment the inventively claimed process for recovering oil from an oil-reservoir comprises the steps of:
a) providing solid particles and water having conductivity in the range of 15 mS/cm to 300 mS/cm,
   whereby the solid particles comprise at least one layered double hydroxide of general formula (I)

[M^{II}₍₁₋ₓ₎M^{III}ₓ(OH)₂]^{x+}[Aⁿ⁻]_{x/n}.y H₂O (I),
wherein
   M^{II} denotes a divalent metal ion or 2 Li,
   M^{III} denotes a trivalent metal ion,
   Aⁿ⁻ denotes at least one n-valent anion comprising:
      (i) a mixture of A1 and A2, or
      (ii) A1,
      whereby
      A1 is selected from the group consisting of alkyl sulfate, alkyl phosphate, alkyl sulfonate, alkyl carboxylate, alkyl phosphonate, alkyl phosphinate and alkyl carbonate, and
      A2 is selected from the group consisting of Cl⁻, Br, OH⁻, NO₃⁻, CO₃²⁻ and SO₄²⁻,
whereby
the ratio of the mixture of A1 and A2 is 1 mol [trivalent metal ion M^{III}]=(1 mol [A1]/valence of A1)+(1 mol [A2]/valence of A2),
   n is 1 to 4,
   x is the mole fraction having a value ranging from 0.1 to 0.5 and
   y is a value ranging from 0 to 5.0,
b) combining the solid particles and water having conductivity in the range of 15 mS/cm to 300 mS/cm with the crude oil in the oil-reservoir,
c) mixing the components of step b) to obtain an emulsion containing droplets, wherein the emulsion comprises the solid-particles, water having conductivity in the range of 15 mS/cm to 300 mS/cm and crude oil,
d) transferring the emulsion out of the oil-reservoir, and
e) recovering the solid particles of the emulsion.

### EXAMPLES

### Methods

### Emulsion Characterization

### Type

The type of emulsion (oil in water type or water in oil type) was determined by conductivity measurement.

After 24 hours from making an emulsion, the conductivity of emulsion was measured with a conductivity meter (LF330, Wissenschaftlich-Technische Werkstätten GmbH). When conductivity of an emulsion is more than 10 μS/cm, it indicates that the emulsion is oil in water type. When conductivity of an emulsion is less than 10 μS/cm, it indicates that the emulsion is water in oil type (Langmuir 2012, 28, 6769-6775).

### Droplet Size

Droplet size of emulsion was measured by the laser diffraction in accordance to ISO13320: 2010-01. The value of Dv₅₀ was used for comparison.

N₂ adsorption desorption isotherms: Langmuir surface areas, BET surface areas, micropore volume, pore volume, micropore size were measured via nitrogen adsorption at 77 K according to DIN 66131: 1993-06 (BET) and DIN 66135-1: 2001-06 (N₂ adsorption). The micropore volume was determined from the t-plot analysis.

X-ray powder diffraction: The determinations of the crystallinities were performed on a D8 Advance series 2 diffractometer from Bruker AXS. The diffractometer was configured with an opening of the divergence aperture of 0.1° and a Lynxeye detector. The samples were measured in the range from 2° to 70° (2 Theta). After baseline 30 correction, the reflecting surfaces were determined by making use of the evaluation software EVA (from Bruker A)(S). The ratios of the reflecting surfaces are given as percentage values.

### SEM

Powder samples were investigated with the field emission scanning electron microscope (FESEM) Hitachi S-4700, which was typically run at acceleration voltages between 2 kV and 20 kV. Powder samples were prepared on a standard SEM stub and sputter coated with a thin platinum layer, typically 5 nm. The sputter coater was the Polaron SC7640. The sizes of LDH particles, diameter and thickness, were counted manually from SEM images. 50 particles were picked up randomly, and their sizes were measured. The averages were defined by the particle sizes. Aspect ratio was determined as the ratio of diameter/thickness.

### Elemental Analysis

Composition of the obtained materials is measured with flame atomic absorption spectrometry (F-AAS) and inductively coupled plasma optical emission spectrometry (ICP-OES).

### AFM

The heights of the particles are measured with atomic force microscopy (AFM). The AFM measurement was performed on Bruker ICON Peak Force Mapping at 1 nN. Bruker MPP12120-10 Model TAP150A was used as a cantilever. Scan frequency was 0.3 Hz. Typically, 5 mg of powder was dispersed in 8 ml of EtOH (dry, Aldrich) with 10 minutes of ultrasonic sound. Then the suspension was dropped onto a freshly cleaved Mica surface and dried under vacuum at room temperature.

### FT-IR Analysis

The functional groups of samples are observed with FT-IR. The FT-IR measurements were performed on a Nicolet 6700 spectrometer with KBr method. Typically, 1 mg of sample and 300 mg of KBr were mixed and grinded in agate mortar, and the mixture was press with 80 kN. The spectra were recorded in the range of 4000 cm⁻¹ to 400 cm⁻¹ at a resolution of 2 cm⁻¹. The obtained spectra were represented by a plot having on the x axis the wavenumber (cm⁻¹) and on the y axis the absorbance (arbitrary units).

### Preparation of Layered Double Hydroxides (LDH)

### Example 1

### Synthesis of Hydrotalcite (Mg²⁺, Al³⁺, CO₃²⁻) (for Comparative Purpose)

Solution A: Mg(NO₃)₂.6H₂O and Al (NO₃)₃.9H₂O were dissolved in deionized water (562.5 ml).

Solution B: NaOH and Na₂CO₃ were dissolved in deionized water (562.5 ml) to form the mixed base solution. Solution A (562.5 ml) and solution B (562.5 ml) were simultaneously added (5 sec.) under stirring to a vessel containing deionized water (450 ml). The pH of the reaction mixture was around 8.55-8.6. The mixing process was carried out at room temperature. The resulting slurry was transferred to an autoclave and aged at 100° C. for 13 h while stirring (150 U/min). The pH of resulting slurry was 8.38. The slurry was filtered, washed well with 23 L of deionized water, and dried at 120° C. overnight.

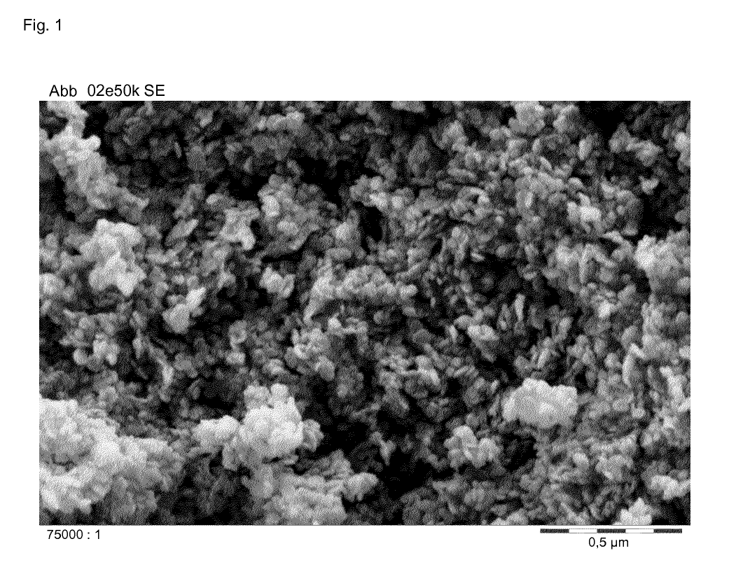

The characterization of the final product by XRD as shown in table 1 shows that the product has the typical layered double hydroxide structure. The SEM image (FIG. 1) shows that the product is a disk shaped material with the diameter of around 50 nm, the thickness of 10-20 nm, and the aspect ratio of 2.5-5. The elemental analysis indicated an elemental composition of Mg (23.0 wt. %) and Al (8.2 wt. %). The N₂ adsorption isotherm measurements indicated that the material has BET surface area of 106.3 m²/g. The AFM observation indicated that the average height of the particles was 20 nm (heights in a range of 15˜24 nm were observed).

TABLE 1

| Number | Angle | d-Spacing | Rel. Intensity |
|---|---|---|---|
| 1 | 11.30 | 7.82 | 100% |
| 2 | 15.20 | 5.83 | 3% |
| 3 | 22.82 | 3.89 | 77% |
| 4 | 26.84 | 3.32 | 3% |
| 5 | 30.72 | 2.91 | 5% |
| 6 | 34.43 | 2.60 | 59% |
| 7 | 38.48 | 2.34 | 29% |
| 8 | 45.54 | 1.99 | 26% |
| 9 | 60.36 | 1.53 | 70% |
| 10 | 61.63 | 1.50 | 69% |
| 11 | 65.42 | 1.43 | 12% |

### Example 2

### Synthesis of Hydrotalcite-Like Compound (Mg²⁺, Fe³⁺, CO₃²⁻) (for Comparative Purpose)

Solution A: Mg(NO₃)₂.6H₂O and Fe (NO₃)₃.9H₂O were dissolved in deionized water (562.5 ml).

Solution B: NaOH and Na₂CO₃ were dissolved in deionized water (562.5 ml) to form the mixed base solution. Solution A (562.5 ml) and solution B (562.5 ml) were simultaneously added dropwise to a vessel containing stirred deionized water (450 ml). The pH of the reaction mixture was around 10.6. The mixing process was carried out at room temperature. The resulting slurry was transferred to autoclave and aged at 100° C. for 13 h with 150 U/min stirring. The pH of resulting slurry was 9.5. The slurry was washed well with deionized water with normal filter, and dried at 120° C. overnight.

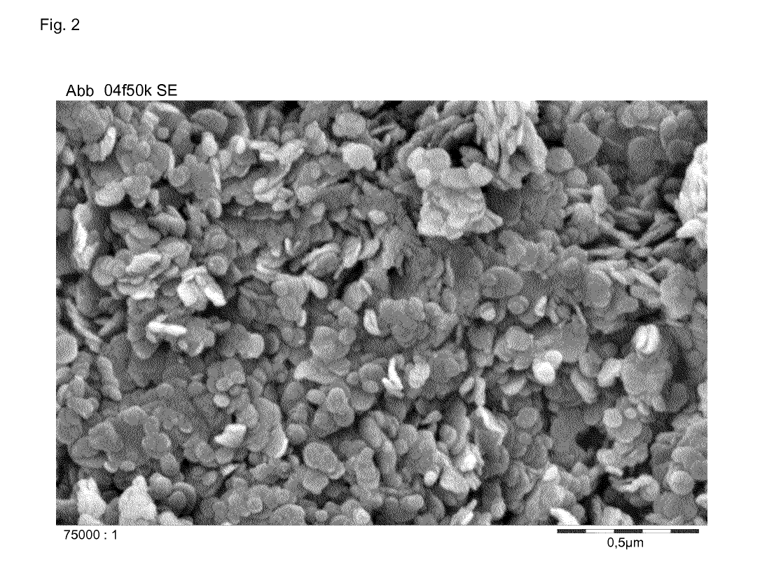

The characterization of the final product by XRD as shown in table 2 shows that the product has the typical layered double hydroxide structure characteristic. The SEM image (FIG. 2) shows that the product is a disk shaped material with the diameter of 30-180 nm, the thickness of around 15 nm, and aspect ratio of 2-12. The elemental analysis indicated an elemental composition of Mg (21.7 wt. %) and Fe (12.6 wt. %). The N₂ adsorption isotherm measurements indicated that the material has BET surface area of 71.0 m²/g. The AFM observation indicated that the average height of the particles was 21 nm (heights in a range of 11˜33 nm were observed).

TABLE 2

| Number | Angle | d-Spacing | Rel. Intensity |
|---|---|---|---|
| 1 | 11.24 | 7.87 | 100% |
| 2 | 15.20 | 5.82 | 6% |
| 3 | 22.67 | 3.92 | 75% |
| 4 | 26.83 | 3.32 | 2% |
| 5 | 30.76 | 2.90 | 7% |
| 6 | 34.00 | 2.63 | 44% |
| 7 | 38.29 | 2.35 | 24% |
| 8 | 45.51 | 1.99 | 20% |
| 9 | 59.38 | 1.56 | 78% |
| 10 | 60.66 | 1.53 | 77% |
| 11 | 64.42 | 1.45 | 15% |

### Ion Exchange of LDHs

The typical procedure for the ion-exchange is as follows: LDH (3.6 g) and the required amount of sodium alkyl sulfates/phosphates were dispersed in distilled water (180 mL) and 10% HNO₃ (7 ml) was added. The mixture was sonicated for 30 minutes and then heated at 50° C. for 2 h, under stirring at 100 rad/s. A molar ratio of surfactant: LDH=1.7−14.1*10⁻²:1. The resulting slurry was filtered in a nitrogen atmosphere, washed with distilled water and a small amount of ethanol. The product was dried in vacuum at 50° C.

### Example 3

Layered double hydroxide (Mg²⁺, Al³⁺, CO₃²⁻) was ion-exchanged with sodium dodecyl sulfate. A molar ratio of surfactant: LDH=2.5*10⁻²:1. Ion-exchange was confirmed with elemental analysis, FT-IR analysis, and AFM observation: The elemental analysis indicated an elemental composition of sulfur with 0.21 wt. % (ca. 76% of sodium dodecyl sulfate was ion-exchanged, calculated based on sulfur contents); FT-IR analysis indicated C—H stretches at 2854 cm⁻¹ and 2924 cm⁻¹; and the AFM observation indicated that the average height of the particles was 34 nm (heights in a range of 33˜34 nm were observed).

### Example 4

Layered double hydroxide (Mg²⁺, Fe³⁺, CO₃²⁻) was ion-exchanged with sodium 1-propanesulfonate monohydrate. A molar ratio of surfactant: LDH=2.6*10⁻²:1. Ion-exchange was confirmed with elemental analysis and FT-IR analysis: The elemental analysis indicated an elemental composition of sulfur with <0.01 wt. % (ca. <4.8% of sodium 1-propanesulfonate monohydrate was ion-exchanged, calculated based on sulfur contents); and FT-IR analysis indicated C—H stretches at 2949 cm⁻¹ and 2973 cm⁻¹.

### Example 5

Layered double hydroxide (Mg²⁺, Fe³⁺, CO₃²⁻) was ion-exchanged with sodium octyl sulfate. A molar ratio of surfactant: LDH=2.6*10⁻²:1. Ion-exchange was confirmed with elemental analysis and FT-IR analysis: The elemental analysis indicated an elemental composition of sulfur with 0.02 wt. % (ca. 9.6% of sodium octyl sulfate was ion-exchanged, calculated based on sulfur contents); and FT-IR analysis indicated C—H stretches at 2921 cm⁻¹ and 2957 cm⁻¹.

### Example 6

Layered double hydroxide (Mg²⁺, Fe³⁺, CO₃²⁻) was ion-exchanged with sodium dodecyl sulfate. A molar ratio of surfactant: LDH=3.5*10⁻²:1. Ion-exchange was confirmed with elemental analysis, FT-IR analysis, and AFM observation: The elemental analysis indicated an elemental composition of sulfur with 0.22 wt. % (ca. 79% of sodium dodecyl sulfate was ion-exchanged, calculated based on sulfur contents); FT-IR analysis indicated C—H stretches at 2854 cm⁻¹ and 2924 cm⁻¹; and the AFM observation indicated that the average height of the particles was 28 nm (heights in a range of 21˜35 nm were observed).

### Example 7

Layered double hydroxide (Mg²⁺, Fe³⁺, CO₃²⁻) was ion-exchanged with sodium hexadecyl sulfate. A molar ratio of surfactant: LDH=5.1*10⁻²:1. Ion-exchange was confirmed with elemental analysis and FT-IR analysis: The elemental analysis indicated an elemental composition of sulfur with 0.43 wt. % (ca. 100% of sodium hexadecyl sulfate was ion-exchanged, calculated based on sulfur contents); and FT-IR analysis indicated C—H stretches at 2851 cm⁻¹ and 2920 cm⁻¹.

### Example 8

Layered double hydroxide (Mg²⁺, Fe³⁺, CO₃²⁻) was ion-exchanged with sodium monododecyl phosphate (mixture of Mono and Disodium Salt). A molar ratio of surfactant: LDH=3.5*10⁻²:1. Ion-exchange was confirmed with elemental analysis and FT-IR analysis: The elemental analysis indicated an elemental composition of phosphorus with 0.01 wt. % (ca. 3.9% of sodium monododecyl phosphate was ion-exchanged, calculated based on sulfur contents); and FT-IR analysis indicated C—H stretches at 2850 cm⁻¹ and 2918 cm⁻¹.

### Example 9

layered double hydroxide (Mg²⁺, Fe³⁺, CO₃²⁻) was ion-exchanged with sodium hexadecyl sulfate. A molar ratio of surfactant: LDH=3.4*10⁻²:1. Ion-exchange was confirmed with elemental analysis and FT-IR analysis: The elemental analysis indicated an elemental composition of sulfur with 0.26 wt. % (ca. 100% of sodium hexadecyl sulfate was ion-exchanged, calculated based on sulfur contents); and FT-IR analysis indicated C—H stretches at 2851 cm⁻¹ and 2919 cm⁻¹.

### Preparation of Emulsions

For evaluating the obtained materials as emulsifier, emulsion test was performed on the inventive LDHs of example 1-8 as well as on sodium dodecyl sulfate and sodium hexadecyl sulfate. The condition of emulsion test is as follows:

1 g of powder and 10 ml of mineral oil (PIONIER 1912, H&R Vertrieb GmbH, 31.4 mPa·s at 20° C.) were added to 90 ml of salt water. The suspension was heated at 60° C. for 1 hour with stirring. After heating, the suspension was stirred with Ultra-turrax with 15′103 rpm for 3 minutes. Salt water was obtained by dissolving 56429.0 mg of CaCl₂.2H₂O, 22420.2 mg of MgCl₂.6H₂O, 132000.0 mg of NaCl, 270.0 mg of Na₂SO₄, and 380.0 mg of NaBO₂.4H₂O to 1 L of deionized water, adjusting pH to 5.5-6.0 with HCl afterwards. The total ion concentration of the salt water was 185 569 mg/L. The conductivity of the salt water was 216 mS/cm.

### Emulsion 1 (Emulsion for Comparative Example)

The compositions of emulsion 1 are as follows: 1 g of hydrotalcite (Mg²⁺, Al³⁺, CO₃²⁻) from example 1, 10 ml of mineral oil (PIONIER 1912, H&R Vertrieb GmbH, 31.4 mPa·s at 20° C.), and 90 ml of salt water.

The conductivity of this emulsion was 148 mS/cm which indicates that this emulsion is oil in water type. The results of laser diffraction indicate that this emulsion has Dv₅₀ of 13.6 μm.

### Emulsion 2

The compositions of emulsion 2 are as follows: 1 g of modified layered double hydroxide (Mg²⁺, Al³⁺, CO₃²⁻) from example 3.10 ml of mineral oil (PIONIER 1912, H&R Vertrieb GmbH, 31.4 mPa·s at 20° C.), and 90 ml of salt water.

The conductivity of this emulsion was 144 mS/cm which indicates that this emulsion is oil in water type. The results of laser diffraction indicate that this emulsion has Dv₅₀ of 8.63 μm.

### Emulsion 3 (Emulsion for Comparative Example)

The compositions of emulsion 3 are as follows: 1 g of hydrotalcite (Mg²⁺, Fe³⁺, CO₃²) from example 2, 10 ml of mineral oil (PIONIER 1912, H&R Vertrieb GmbH, 31.4 mPa·s at 20° C.), and 90 ml of salt water.

The conductivity of this emulsion was 151 mS/cm which indicates that this emulsion is oil in water type. The results of laser diffraction indicate that this emulsion has Dv50 of 13.7 μm.

### Emulsion 4

The compositions of emulsion 4 are as follows: 1 g of modified layered double hydroxide (Mg²⁺, Fe³⁺, CO₃²⁻) from example 4, 10 ml of mineral oil (PIONIER 1912, H&R Vertrieb GmbH, 31.4 mPa·s at 20° C.), and 90 ml of salt water.

The conductivity of this emulsion was 11.87 mS/cm which indicates that this emulsion is oil in water type. The results of laser diffraction indicate that this emulsion has Dv₅₀ of 13.6 μm.

### Emulsion 5

The compositions of emulsion 5 are as follows: 1 g of modified layered double hydroxide (Mg²⁺, Fe³⁺, CO₃²⁻) from example 5, 10 ml of mineral oil (PIONIER 1912, H&R Vertrieb GmbH, 31.4 mPa·s at 20° C.), and 90 ml of salt water.

The conductivity of this emulsion was 2.84 mS/cm which indicates that this emulsion is oil in water type. The results of laser diffraction indicate that this emulsion has Dv₅₀ of 12.4 μm.

### Emulsion 6

The compositions of emulsion 6 are as follows: 1 g of modified layered double hydroxide (Mg²÷, Fe³⁺, CO₃²⁻) from example 6, 10 ml of mineral oil (PIONIER 1912, H&R Vertrieb GmbH, 31.4 mPa·s at 20° C.), and 90 ml of salt water.

The conductivity of this emulsion was 150 mS/cm which indicates that this emulsion is oil in water type. The results of laser diffraction indicates that this emulsion has Dv₅₀ of 8.51 μm.

### Emulsion 7

The compositions of emulsion 7 are as follows: 1 g of modified layered double hydroxide (Mg²⁺, Fe³⁺, CO₃²⁻) from example 7, 10 ml of mineral oil (PIONIER 1912, H&R Vertrieb GmbH, 31.4 mPa·s at 20° C.), and 90 ml of salt water.

The conductivity of this emulsion was 22.1 mS/cm which indicates that this emulsion is oil in water type. The results of laser diffraction indicate that this emulsion has Dv₅₀ of 6.55 μm.

### Emulsion 8

The compositions of emulsion 8 are as follows: 1 g of modified layered double hydroxide (Mg²⁺, Fe³⁺, CO₃²⁻) from example 8, 10 ml of mineral oil (PIONIER 1912, H&R Vertrieb GmbH, 31.4 mPa·s at 20° C.), and 90 ml of salt water.

The conductivity of this emulsion was 255 mS/cm which indicates that this emulsion is oil in water type. The results of laser diffraction indicates that this emulsion has Dv₅₀ of 12.0 μm.

### Emulsion 9 (Emulsion for Comparative Example)

The compositions of emulsion 9 are as follows: 1 g of sodium dodecyl sulfate, 10 ml of mineral oil (PIONIER 1912, H&R Vertrieb GmbH, 31.4 mPa·s at 20° C.), and 90 ml of salt water.

The outcome was not an emulsion but two phases with oil and water.

### Emulsion 10 (Emulsion for Comparative Example)

The compositions of emulsion 10 are as follows: 0,043 g of sodium hexadecyl sulfate, 10 ml of mineral oil (PIONIER 1912, H&R Vertrieb GmbH, 31.4 mPa·s at 20° C.), and 90 ml of salt water.

The outcome was not an emulsion but two phases with oil and water.

### Emulsion 11

The compositions of emulsion 11 are as follows: 1 g of modified layered double hydroxide (Mg²⁺, Fe³⁺, CO₃²⁻) from example 9, 10 ml of crude oil (Bockstedt oil, Wintershall, 6 mPa·s at 20° C.) according to DIN 53019-1:2008-09), and 90 ml of salt water.

The conductivity of this emulsion was 217 mS/cm which indicates that this emulsion is oil in water type. The result of laser diffraction indicates that this emulsion has Dv₅₀ of 12.9 μm.

### Emulsion 12

The compositions of emulsion 12 are as follows: 1 g of modified layered double hydroxide (Mg²÷, Fe³⁺, CO₃²⁻) from example 6, 10 ml of crude oil (Emlicheim oil, Wintershall, 13 mPa·s at 20° C. according to DIN 53019-1:2008-09), and 90 ml of salt water.

The conductivity of this emulsion was 158 mS/cm which indicates that this emulsion is oil in water type. The result of laser diffraction indicates that this emulsion has Dv₅₀ of 13.1 μm.

### Stability and Permeability of the Emulsions

### Sand-Packed Column Experiments

Flow of the emulsion through porous media, i.e. sandstone or packed sand is essential for practical application. The following experiments allow us to examine the permeability of the obtained emulsion.

A cylinder with height of 200 mm and diameter of 15 mm was used for a vessel. Sand provided by Wintershall (Well: Bockstedt-83) was put into the cylinder until its height be 100 mm. The sand was not pretreated with water and/or oil. After that, 50 ml of emulsion was poured into the cylinder with 20 ml/min. The amounts of emulsion which went through the sand and droplet size of the emulsion were used as a measure of the ability of the emulsion to flow through the packed column without destruction of the emulsion.

### Example 1

### Comparative

The sand-packed column experiment was carried out with emulsion 1 as described above. 31.4% of the emulsion was recollected after passing through the column.

### Example 2

The sand-packed column experiment was carried out with emulsion 2 as described above. 73.5% of the emulsion was recollected after passing through the column.

### Example 3

### Comparative

The sand-packed column experiment was carried out with emulsion 3 as described above. 57.6% of the emulsion was recollected after passing through the column.

### Example 4

The sand-packed column experiment was carried out with emulsion 7 as described above. <99.9% of the emulsion was recollected after passing through the column.

1.-15. (canceled)

16. A process for recovering oil from an oil-reservoir comprising at least the steps of:
a) providing solid particles and water,
wherein the solid particles comprise at least one layered double hydroxide of general formula (I)
[M^{II}₍₁₋ₓ₎M^{III}ₓ(OH)₂]^{x+}[Aⁿ⁻]_{x/n}.y H₂O (I),
wherein
M^{II} denotes a divalent metal ion or 2 Li,
M^{III} denotes a trivalent metal ion,
Aⁿ⁻ denotes at least one n-valent anion comprising:
a mixture of A1 and A2, or
(ii) A1,
wherein
A1 is selected from the group consisting of alkyl sulfate, alkyl phosphate, alkyl sulfonate, alkyl carboxylate, alkyl phosphonate, alkyl phosphinate and alkyl carbonate, and
A2 is selected from the group consisting of COO⁻, C₂O₄²⁻, F⁻, Cl⁻, Br⁻, I⁻, OH⁻, CN⁻, NO₃⁻, NO₂⁻, ClO⁻, ClO₂⁻, ClO₃⁻, ClO₄⁻, MnO₄⁻, CH₃COO⁻, HCO₃⁻, H₂PO₄⁻, HSO₄⁻, HS⁻, SCN⁻, [Al(OH)₄]⁻, [Al(OH)₄(H₂O)₂]⁻, [Ag(CN)₂]⁻, [Cr(OH)₄]⁻, [AuCl₄]⁻, SO₃²⁻, S₂O₃²⁻, CrO₄²⁻, Cr₂O₇²⁻, HPO₄²⁻, [Zn(OH)₄]²⁻, [Zn(CN)₄]², [CuCl₄]²⁻, PO₄³⁻, [Fe(CN)₆]³⁻, [Ag(S₂O₃)₂]³⁻, [Fe(CN)₆]⁴⁻, CO₃²⁻, SO₄²⁻ and SeO₄²⁻,
wherein
the ratio of the mixture of A1 and A2 is 1 mol [trivalent metal ion M^{III}]=(1 mol [A1]/valence of A1)+(1 mol [A2]/valence of A2),
n is 1 to 4,
x is the mole fraction having a value ranging from 0.1 to 0.5 and
y is a value ranging from 0 to 5.0,
b) combining the solid particles and water with the oil in the oil-reservoir,
c) mixing the components of step b) to obtain an emulsion containing droplets, wherein the emulsion comprises the solid-particles, water and oil,
d) transferring the emulsion out of the oil-reservoir, and
e) recovering the solid particles of the emulsion.

17. The process according to claim 16, wherein the water has a total ion concentration in the range of 3000 to 300 000 mg/l.

18. The process according to claim 16, wherein the water has conductivity in the range of 8 mS/cm to 300 mS/cm.

19. The process according to claim 16, wherein the oil-reservoir is a subterranean oil-containing formation.

20. The process according to claim 16, wherein the emulsion is a solid particles-stabilized emulsion.

21. The process according to claim 16, wherein A1 is selected from the group consisting of alkyl sulfate and alkyl phosphate and A2 is selected from the group consisting of Cl⁻, Br, OH⁻, NO₃⁻, CO₃²⁻ and SO₄²⁻.

22. The process according to claim 16, wherein A1 is selected from the group consisting of alkyl sulfate and alkyl phosphate and A2 is selected from the group consisting of CO₃²⁻ and Cl⁻.

23. The process according to claim 16, wherein A1 is an alkyl sulfate selected from the group consisting of octyl sulfate, decyl sulfate, dodecyl sulfate, tetradecyl sulfate, hexadecyl sulfate and octadecyl sulfate.

24. The process according to claim 16, wherein the emulsion comprises 9.9 to 90% by weight water, 10 to 90% by weight oil and 0.1 to 10% by weight of at least one layered double hydroxide of general formula (I), related to the overall weight of the emulsion.

25. The process according to claim 16, wherein the solid particles are delaminated by the treatment with an alcohol at a temperature in the range from 50° C. to 100° C. for 1 h to 30 h.

26. The process according to claim 16, wherein the oil is crude oil.

27. The process according to claim 16, wherein the emulsion has a viscosity at 20° C. in the range of 5 to 30 mPa·s under shear rate of 10/s according to DIN 53019-1:2008-09.

28. The process according to claim 16, wherein the droplets of the emulsion have an average droplet size Dv₅₀ in the range of 1 to 13 μm determined according to ISO13320: 2010-01.

29. The process according to claim 16 wherein the subterranean oil-containing formation has pores and the emulsion is obtained by transporting the solid particles and water through these pores.

30. The process according to claim 16, wherein the oil has a viscosity in the range of 1 to 5000 mPa·s at a temperature of 20° C. according to DIN 53019-1:2008-09.
